(19) United States
(12) Patent Application Publication
(10) Pub. No.: US 2019/0228491 A1
(43) Pub. Date: Jul. 25, 2019

(54) IDENTITY OR BACKGROUND VERIFICATION

(71) Applicant: Anupama Padiadpu Subramanya Bhat, Costa Mesa, CA (US)

(72) Inventor: Anupama Padiadpu Subramanya Bhat, Costa Mesa, CA (US)

(21) Appl. No.: 16/255,783

(22) Filed: Jan. 23, 2019

Related U.S. Application Data
(60) Provisional application No. 62/621,025, filed on Jan. 23, 2018.

(51) Int. Cl. G06Q 50/26; H04L 29/06

(52) U.S. Cl. CPC G06Q 50/265; H04L 63/126

(57) ABSTRACT

A computing-device implemented method of ensuring verified direct or indirect communication between a new user and one or more existing users of an application platform is provided. The method may solicit the relevant information about the new user using the computing device; analyze the solicited relevant information; create a profile of the new user within the application platform; determine when the new user attempts to engage in direct or indirect communication with one or more existing users; solicit relevant identity or background information of the new user; and communicatively couple the application platform to identity or background verification agencies.

### CROSS REFERENCE TO RELATED APPLICATIONS

This application claims priority to U.S. Provisional Application No. 62/621,025 filed on Jan. 23, 2018, which is incorporated by reference in its entirety for all purposes.

### TECHNICAL FIELD

Embodiments of the present invention generally relate to a computing-device implemented identity or background verification and more particularly to performing identity or background verification when two people engage in direct or indirect communication using computing devices.

### BACKGROUND OF THE INVENTION

There are many situations in which it is desirable to acquire personalized identity or background information of an individual. For example, for a commercial service, it may be necessary to conduct an identity or background investigation on an individual, who seeks employment or housing. In conducting such an investigation, it is common for employers and landlords to retain an outside investigative service to perform the background check. In such cases, the commercial entity will typically conduct the background check by searching a number of public and/or proprietary databases, such as to verify sexual offender history, bank records, credit history, employment history, arrest records, etc. The individual may be asked to supply some basic information (e.g., social security number, last employer name, previous mailing address, driver's license number, etc.) in an application form, and in some cases to pay a fee associated with obtaining the background check. Thus, the entire burden of obtaining and evaluating the background check falls almost entirely on the entity seeking the information, e.g., the employer or landlord. Furthermore, the types of information that can be acquired by a third-parties (e.g., the employer, the landlord, etc.) is limited since the information is not requested (or authorized) by the individual themselves. Thus, many entities just skip the background check entirely and simply hope that the individual is who he or she purports to be (e.g., non-violent, financially stable, not convicted of certain felonies, etc.).

But the necessity for identity or background verification is not limited to commercial services. For example, in this day and age, identity or background verification is highly relevant for social services. For example, when one or more persons interact with each other on the internet (e.g., for example through social media, dating applications, social event organizations applications, such as Meetups, etc.), they may want to make sure it is safe to provide their personal information, such as address, phone numbers, social media contact information, etc. to each other. While the increasing availability of such easy opportunities of connecting with one another on a global scale have opened the world like never before, they have also exposed the participants to serious security risks. For example, there have been many reports of deaths and sexual assaults on dates organized through dating application platforms exposing a serious security flaw in them. Sexual predators, murderers, and other felons have the same access to these application platforms as others and often use these dating applications as a medium to prey on victims. Additionally, in such cases, it is often hard to call a helpline or friend as the situation is too dangerous and can aggravate at any moment and the affected person is usually already too involved in the situation. These situations are obviously not just limited to dates.

Currently there is no practical way for people using the internet for such commercial and social services to verify the accuracy of the personal information received from other users and where the onus is on the persons using the services to verify their own background. Accordingly, there is a need for an efficient way to verify the background information of the users of the commercial and social services that minimizes the risk for the users.

### SUMMARY OF THE INVENTION

Provided herein are embodiments of a computer-implemented method of ensuring verified direct or indirect communication between a new user and one or more existing users of an application platform. The method may solicit the relevant information about the new user using the computing device; analyze using an analyzing module the solicited relevant information; create a profile of the new user within the application platform using a processing module that takes into account the solicited relevant information; determine when the new user attempts to engage in direct or indirect communication with one or more existing users; solicit relevant identity or background information of the new user; and communicatively couple the application platform to identity or background verification agencies.

Other features and advantages of the present invention will be or will become apparent to one with skill in the art upon examination of the following figures and detailed description, which illustrate, by way of examples, the principles of the present invention.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates an exemplary application platform that is being displayed on a computing device, according to exemplary embodiments of the present invention.

FIGS. 2 and 3 illustrate additional information that may be gathered by the application platform opened on a computing device, according to exemplary embodiments of the present invention.

FIG. 4 illustrates exemplary perks offered to users who opt-in for identity or background verification, according to exemplary embodiments of the present invention.

FIG. 5A illustrates exemplary disclosure statements, according to exemplary embodiments of the present invention.

FIG. 5B illustrates exemplary statements describing a user's rights under the Fair Credit Reporting Act (FCRA), according to exemplary embodiments of the present invention.

FIGS. 5C and 5D illustrate portals to collect a user's consent, according to exemplary embodiments of the present invention.

FIG. 6 illustrates an exemplary flowchart for providing users access to engage in direct or indirect communication with each other, according to exemplary embodiments of the present invention.

### DETAILED DESCRIPTION

The below described figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

Embodiments of the present invention describe various methods of verifying identity or background information of users using computing devices—including but not limited the phones, tablets, computers, AR/VR devices, televisions, and any electronic device that is capable of being connected to the internet—for social and commercial services. These computing devices are disclosed to include any associated hardware and software components, such as the appropriate operating software, processing systems, transmitters, etc. Additionally, such identity or background information may include criminal history, civil judgment history, drug screening history, education history, and any other information that can be legally obtained and used to know about a particular individual.

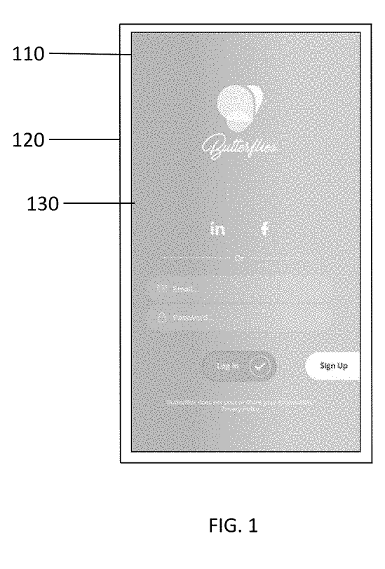

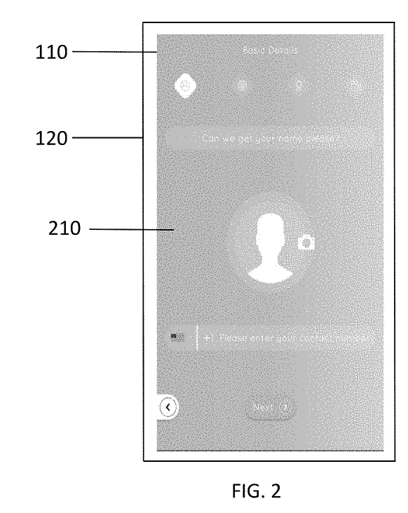

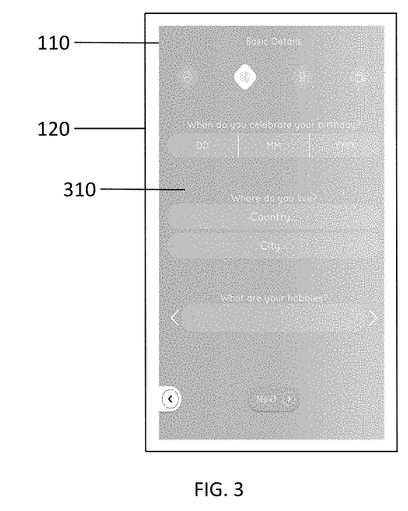

Turning to the figures, FIG. 1 illustrates an exemplary application platform 110 that is being displayed on a computing device 120. While the exemplary application platform 110 illustrates the application platform Butterflies, it is not limited to just that. Any other application that can be opened on a computing device may be used in place. FIG. 1 illustrates the sign-up/sign-in page 130 of the application as it would appear on the computing device. In some embodiments, the application platform Butterflies may have any features that are conventionally available in any other application platform or even one or more application platforms that allow direct or indirect communications between users. For example, the application Platform can have features of AirBnb, Tinder, Lyft, Meetup, etc. In some embodiments, the application platform may have its own new features or a combination of features from existing application platforms and new features. For example, it may allow users that wish to date each other to meet each other without having to engage in any small talk based on their calendar entries, GPS location, age, education backgrounds, etc. As another example, the application platform Butterflies (or any other application with any other name) may allow syncing of two third-party application platforms or that particular application platform with another third-party application platform. For example, the application platform may allow to sync Tinder with Meetup or Uber to facilitate the users using all their services together. The details illustrated in the sign-up/sign-in page 130 (and any other pages described herein) are provided only for exemplary purposes and may be different based on the application platform 110 or the computing device 120. In some embodiments, the first step may be that a user commences the application platform 110 on a computing device 120. FIGS. 2 and 3 illustrate additional information that may be gathered by the application platform 110 opened on a computing device 120 in order for a user to sign-up for the application platform. This additional information may be in separate pages 210 and 310, as illustrated in FIGS. 2 and 3, respectively, within the application platform 110. In other embodiments, the additional information may all be included in one page. As illustrated, the application platform 110 may seek some basic information such as name, age, and location of the user. In some embodiments, it may also seek contact and other information of the user, such as social media profile, photos, e-mail address, phone numbers, etc.

Once the user signs up for the application platform 110, the user may not have a profile that can be used with the application platform 110. Once the user begins using the application platform 110, there may be instances where the user is directly or indirectly interacting with one or more users of the application platform 110. For example, in a roommate search application, a person searching for a roommate may reach out to the user or vice versa. Another example is when the user matches with another user in a dating application. Another example is when the user tries to join a particular group on social media. Another example is when a user tries to book a taxi, or a ride share service. These examples are non-limiting as any situation where any direct or indirect communication between users over the internet (e.g., within an application platform or between multiple application platform) and using a computing a device is within the scope of this disclosure.

In some embodiments, once the user tries to engage in the direct or indirect communication with one or more users of the application platform 110, the user may be prompted to provide additional information that may be required to perform the identity or background verification, such as the user's social security number or any other personal information. Some or all of the relevant identity or background verification information like the social security number may be encrypted. In some embodiments, the application platform 110 may only have the encrypted information. In some embodiments, the identity or background verification agencies and/or the user supplying the relevant identity or background verification information may be the only parties capable of decrypting the relevant identity or background verification information. In some embodiments, this step of information gathering may be accomplished at the sign-up/sign-in stage described in FIGS. 1-3. But either way, before the user is successfully able to engage in the direct or indirect communication, the user may have to agree that the application platform 110 can verify the identity or background of the user. For example, before the user can chat with another user with whom the user matched on a dating application, the user may have to agree to verify their identity or background.

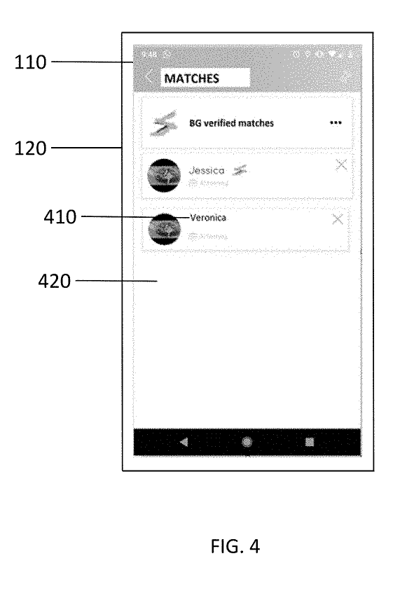

The identity or background verification may be done using consumer reporting agencies (CRAs) that gather publicly available data to conduct identity or background verification in a way that complies with FCRA requirements. In some embodiments, non-FCRA-compliant agencies may be used for identity or background verification. This publicly available data generally originates from local, state, and national law enforcement and government databases. The identity or background verification step may be mandatory or optional. The users of the application may be able to configure their profiles and set for themselves whether they either wish their own profiles or the profiles of the users they directly or indirectly communicate with to be subject to identity or background verification. In some embodiments, there may be incentives for users to subject their or others' profiles to identity or background verification. For example, the users that opt-in for identity or background verification may have some feature on their profile that highlights their choice. For example, the users that opt-in for the identity or background verification may get a virtual badge, star, etc. that may give them specific rewards that may be monetary or non-monetary in nature. For example, in the context of a dating application platform, the users that opt-in for the identity or background verification may get additional matches per day or be able to send a message without even matching with another user. As another example, the users 410 who opt-in for identity or background verification may be featured as verified matches on a separate page 420 of the application platform 110 on the computing device 120 as illustrated in FIG. 4. In some embodiments, the existing users may be able to list/rank the verified users and the non-verified users within the same page or different pages of the application platform 110. The verified users may have a specific designation (symbolic or otherwise) that would provide the existing users with assurance that those users are verified. Any other specific reward depending on the application platform 110 and the computing device 120 may be provided for users that opt-in for identity or background verification. In some embodiments, the application platform 110 may prompt the user to opt-in for the identity or background verification with messages, such as “For the benefit of the safety satiation of your matches, would you like to perform a time background verification? Perks: Get exclusive invites to X events near your GPS location if you are background verified.” In some embodiments, as opposed to the new users, the pre-existing users of the application platform 110 may be given the option of whether they wish that the new users with whom they wish to engage in direct or indirect communication have an identity or background verification done.

In some embodiments, whenever a user opts-in for the user's own identity or background verification, the user may be directed to a separate page where (or within the same page) the user may be asked to pay for the identity or background verification. The cost for the same may depend on the application and/or the CRA fees, which may be dependent on the volume of the users. The fee may be one time or repetitive.

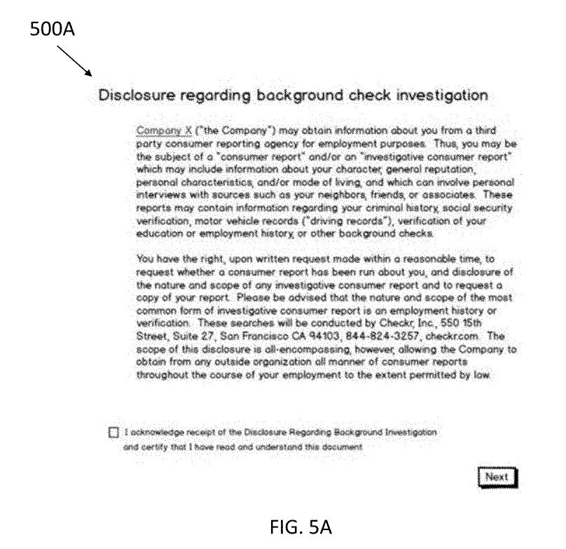

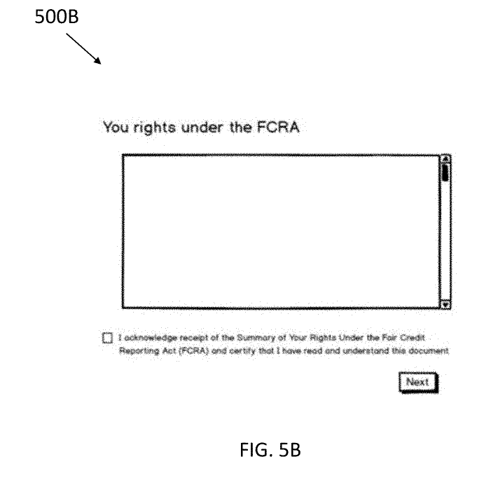

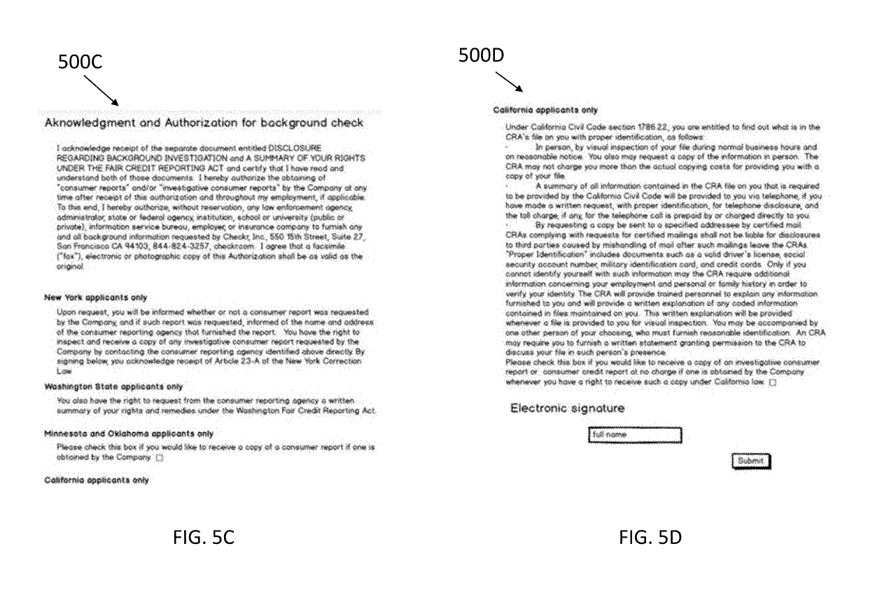

When the user opts-in for the identity or background verification, the application platform 110 will disclose all the legally relevant information. Some exemplary disclosure statements 500A are illustrated in FIG. 5A. The application platform 110 may also display the user's rights 500B under the FCRA as illustrated in FIG. 5B. The application platform 110 may also collect the user's consent with an authorization form 500C and 500D in FIGS. 5C and 5D, respectively, to confirm their decision to opt-in for the identity or background verification. Once the application platform 110 receives all the information it needs, it will perform the identity or background verification using an FCRA-compliant or non-compliant agency to which the application platform may be communicatively linked through an available means, such as the internet, Bluetooth®, etc. In some embodiments, the user may be notified that the results of the identity or background verification may influence their ability to use the application platform 110.

Once the application platform 110 gets the results of the identity or background verification, it may notify the user of the same and whether may use the application platform 110. The user may get the results of the identity or background verification separately or through the application 110. The results may be described in a “pre-adverse action notice.” The application platform 110 may get the copy of the results of the identity or background verification first. Upon receiving the results, the application platform 110 may provide a copy of the results to the user along with the name, address, and phone number of the identity or background screening company that generated the results. In some embodiments, the application platform 110 may also include a copy of the user's rights under the FCRA. The application platform 110 may also allow the user a set amount of time to file a dispute if the user contests the results. In some embodiments, the user 110 that successfully contests the results and obtains a positive result may submit the same to the application 110 and get access to the application. I.e., a positive result is any result that the application platform 110 considers satisfactory to allow a user to access to the application platform and for the user to engage in direct or indirect communication with other existing users of the application platform. A negative result may be one that the application platform 110 does not consider satisfactory. Also, within the scope of the disclosure is direct or indirect communication between a new user of the application platform 110 and any other application platform. In some embodiments, the contest results may be directly received by the application platform 110 itself. If the user is denied access to the application platform 110, in some embodiments, a written notice may be sent to the user stating the same. These steps may be illustrated in different pages of the application platform 110. In some embodiments, the user may be able to contest the results using pages of the application 110, i.e., in some embodiments, the application platform 110 may act as a portal for a user to contest the results.

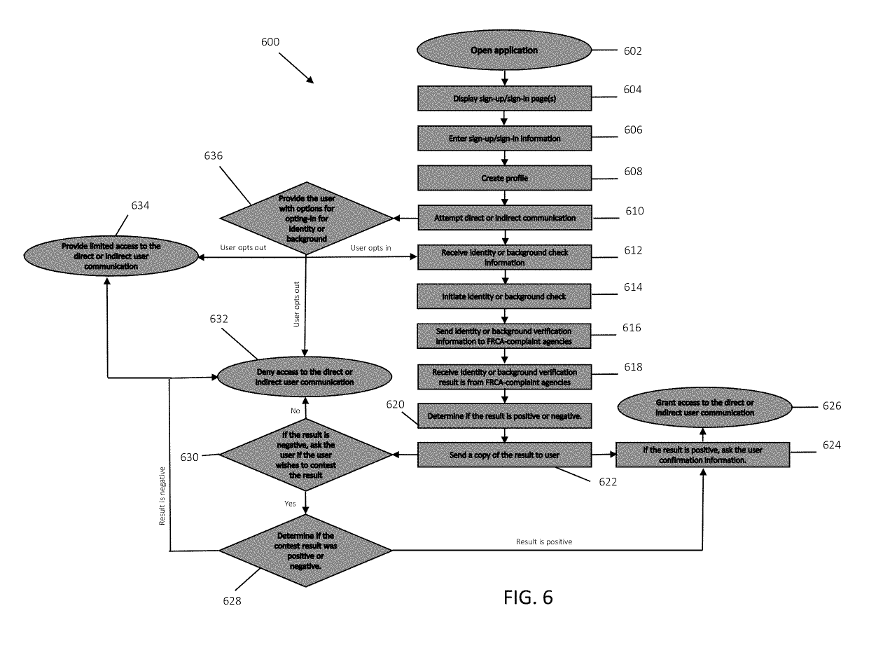

FIG. 6 illustrates an exemplary flowchart 600 exhibiting the steps that maybe followed to ensure identity or background verified communication between two or more users of an application platform in some embodiments of the present invention. As illustrated, first the user may open the application 602. Next, the application may display the sign-up/sign-in page 604. The user may then enter/input the sign-up/sign-in information 606 in order to create a profile 608. The application may comprise a processing module to process all the sign-up/sign-in information to create the profile. The profile may have a configuration module that allows the users to select and highlight various features of the profile depending on the user's needs. Once the profile is created 608, the user may attempt to engage in direct and indirect communications 610 with other users. At this point or as soon as the user enters the sign-up/sign-in information 606 or once the profile is created 608, the user may be required to select if they want in to opt-in for the identity or background verification 636. In some embodiments, the identity or background verification step may be mandatory, and the user may just be required to provide the relevant information required for the identity or background verification 612. This step may occur at any stage of the illustrated process. In the non-mandatory embodiments, the user's choice to opt-in or not may lead to different results. For example, if the user chooses to not opt-in, the user may not be given further access to engage in direct or indirect communication with other users 632. In other embodiments, the user's decision to not opt-in may give the user limited access to engage in direct or indirect communication with other users 634. In some embodiments, the application platform 110 may have the identity or background verification be mandatory or non-mandatory at various portions of the application platform 110. This limited access may mean any sort of access that has less perks than the access given to users who choose to opt-in for the identity or background verification. If the user opts-in for the identity or background verification, the user may be required to provide the relevant information required for the identity or background verification 612. Once the user provides the relevant information, the computing-device may process that information using a processing module and may provide the user various options of FCRA-compliant agencies that they wish to use for the identity or background verification. The options may also present non-FCRA-compliant agencies and the use of the same for all the enumerated steps is within the scope of this disclosure. The list non-FCRA and FCRA-compliant agencies may be generated using an analyzing module that takes into account the relevant information and matches that with various available non-FCRA and FCRA-compliant agencies that may be stored in a database. This database may be operated by a third-party or by the party running the application. In other embodiments, one or more non-FCRA and/or FCRA-compliant agencies may be chosen by the application itself based on the processed relevant information. At any stage of this process, from when the sign-up/sign-in information is displayed to before the identity or background verification is initiated 614, the user may be required to provide payment information for the identity or background verification. Once the payment information is processed successfully (using a third-party source or the party running the application), the relevant information may be transmitted to the appropriate non-FCRA and/or FCRA-compliant agencies 616 to conduct the identity or background verification. Once the appropriate non-FCRA and/or FCRA-compliant agencies conduct the identity or background verification, they will transmit the results to the application 618 and also at times to the user. If the results are not transmitted to the user by the FCRA-compliant agencies, the result may be processed and transmitted to the user by the application on the computing device or in some embodiments, a physical copy of the result may be sent to them 622. The result may be transmitted to the user before or after the application analyzes using an analyzing module whether the result is positive or negative 620. If the result of the identity or background verification is positive, then the user may be required to provide additional confirmation 624. In some embodiments, this step may not exist, and the user may just be given access to engage in direct or indirect communication with other users 626. If the result of the identity or background verification is negative, the user may be given an option to contest the result 630. If the user contests the results, the user may do so separately or by just using the application platform 110. The application platform 110 may provide options to do so on the computing device. Once the user contests the results, the contest result may again be sent to the user directly or to the application platform 110 or to the user and the application platform 110. The application platform 110 may again process if the contest result is positive or negative 628. If the contest result is positive, then the user may be directed to steps 624 or 626. If the contest result is negative, the user may either be directed to step 632 or 634.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

What is claimed is:

1. A computing-device implemented method of verifying the identity of a user, comprising:
providing an application platform;
soliciting the relevant information about the user using the computing device into the application platform;
analyzing using an analyzing module the solicited relevant information;
creating a profile of the user within the application platform using a processing module that takes into account the solicited relevant information;
soliciting relevant identity or background information; and
communicatively coupling the application platform to one or more identity or background verification agencies.

2. The computing-device implemented method of verifying the identity of a user of claim 1, wherein the application platform facilitates the syncing of two third-party application platforms or the particular application platform with another third-party application platform.

3. The computing-device implemented method of verifying the identity of a user of claim 1, wherein the relevant identity or background information further comprises the social security number of the user.

4. The computing-device implemented method of verifying the identity of a user of claim 1, wherein the identity or background information verification agencies are FCRA complaint.

5. The computing-device implemented method of verifying the identity of a user of claim 1 further comprising transmitting the relevant identity or background information to the identity or background verification agencies.

6. The computing-device implemented method of verifying the identity of a user of claim 1 further comprising receiving the results of the identity or background verification from the identity or background verification agencies.

7. The computing-device implemented method of verifying the identity of a user of claim 1 further comprising analyzing using an analyzing module the results of the identity or background verification.

8. The computing-device implemented method of verifying the identity of a user of claim 7, wherein analyzing the results of the identity or background verification further comprises determining if the result is positive or negative.

9. The computing-device implemented method of verifying the identity of a user of claim 8 further comprising transmitting to the user the results of the identity or background verification.

10. The computing-device implemented method of verifying the identity of a user of claim 9 further comprising providing the user with an option to contest the results of the identity or background verification.

11. A computing-device implemented method of ensuring verified direct or indirect communication between a new user and one or more existing users of an application platform, comprising:
soliciting the relevant information about the new user using the computing device;
analyzing using an analyzing module the solicited relevant information;
creating a profile of the new user within the application platform using a processing module that takes into account the solicited relevant information;
determining when the new user attempts to engage in direct or indirect communication with one or more existing users;
soliciting relevant identity or background information of the new user; and
communicatively coupling the application platform to one or more identity or background verification agencies.

12. The computing-device implemented method of ensuring verified communication between a new user and one or more existing users of an application platform of claim 11, wherein the relevant information further comprises the name, age, and location of the user.

13. The computing-device implemented method of ensuring verified communication between a new user and one or more existing users of an application platform of claim 11, wherein the relevant identity or background information further comprises the social security number of the user.

14. The computing-device implemented method of ensuring verified communication between a new user and one or more existing users of an application platform of claim 11, wherein the identity or background information verification agencies are FCRA complaint.

15. The computing-device implemented method of ensuring verified communication between a new user and one or more existing users of an application platform of claim 11 further comprising transmitting the relevant identity or background information to the identity or background verification agencies.

16. The computing-device implemented method of ensuring verified communication between a new user and one or more existing users of an application platform of claim 11 further comprising receiving the results of the identity or background verification from the identity or background verification agencies.

17. The computing-device implemented method of ensuring verified communication between a new user and one or more existing users of an application platform of claim 16 further comprising analyzing using an analyzing module whether the results of the identity or background verification are positive or negative.

18. The computing-device implemented method of ensuring verified communication between a new user and one or more existing users of an application platform of claim 17, wherein if the results are positive, providing access to the new user to engage in direct or indirect communication with the existing one or more users.

19. The computing-device implemented method of ensuring verified communication between a new user and one or more existing users of an application platform of claim 17, wherein if the results are negative, providing limited access to the new user to engage in direct or indirect communication with the existing one or more users.

20. The computing-device implemented method of ensuring verified communication between a new user and one or more existing users of an application platform of claim 17, wherein if the results are negative, providing the new user with a means to contest the results of the results of the identity or background verification.
